(19) United States
(12) Patent Application Publication
(10) Pub. No.: US 2007/0204303 A1
(43) Pub. Date: Aug. 30, 2007

(54) Apparatus and method for transmitting DMB program information in DMB receiving terminal

(75) Inventor: Kyoung-Ho Lee, Namyangju-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/704,723

(22) Filed: Feb. 9, 2007

(30) Foreign Application Priority Data
Feb. 10, 2006 (KR) P2006-13293

(51) Int. Cl. H04N 5/445; G06F 13/00

(52) U.S. Cl. 725/50; 725/39; 725/51

(57) ABSTRACT

Provided is an apparatus and method for transmitting digital multimedia broadcasting (DMB) program information in a DMB receiving terminal. If a user desires to recommend a broadcasting program to another user, the DMB receiving terminal extracts broadcasting information of the selected broadcasting program, searches for broadcasting program information corresponding to the extracted broadcasting information from Electronic Program Guide (EPG) data, generates Caller Information Sending Service (CISS) information including the found broadcasting program information, and transmits a call signal including the CISS information to a specific recipient so that the CISS information is stored as call-record information in a DMB receiving terminal of the specific recipient. Then, the recipient can check the broadcasting program using the CISS information. Accordingly, broadcasting program information of DMB can be easily exchanged between users.

### PRIORITY

This application claims priority under 35 U.S.C. §119 to an application entitled “Apparatus and Method for Transmitting DMB Program Information in DMB Receiving Terminal” filed in the Korean Intellectual Property Office on Feb. 10, 2006 and assigned Serial No. 2006-13293, the contents of which are incorporated herein by reference.

### BACKGROUND OF THE INVENTION

1. Field of the Invention

The present invention relates generally to a digital multimedia broadcasting (DMB) receiving terminal, and in particular, to the usage of an Electronic Program Guide (EPG) service received by a DMB receiving terminal.

2. Description of the Related Art

DMB is a broadcasting service for providing a high quality moving picture service using digital data. An EPG service allows users to refer to information on DMB programs broadcasted by a DMB station by providing various types of information related to DMB programs to users in the DMB station. For example, the EPG service provides information for notifying users of the types, channels, and start and end times of currently provided DMB programs.

This information is transmitted with DMB data for DMB programs from the DMB station. A DMB receiving terminal, which has received the information, generates broadcasting guide information of the DMB programs broadcasted by the DMB station using the received information and stores the generated broadcasting guide information in a memory. The broadcasting guide information is output to a user upon request. Hereinafter, information received from a DMB station by a DMB receiving terminal to generate broadcasting guide information is called EPG data. Thus, a user of the DMB receiving terminal can select and view a desired broadcasting program using the EPG data.

The rapid development of DMB technology has caused a significant increase of DMB channels, making it difficult for a user to search for a desired broadcasting program. Thus, the user must at times request assistance in searching for a desired broadcasting program by exchanging information with other users. This exchange of information can accelerate the popularization of DMB, and can reduce the time a user spends searching a menu for a desired broadcasting program.

A conventional DMB receiving terminal does not have a proper method for a user to exchange information regarding a specific broadcasting program with other users. Specifically, in order for a user to recommend a specific broadcasting program to a recipient using the conventional DMB receiving terminal, the user must provide information on a start time, a channel and a name of the specific broadcasting program to another user by directly making a phone call or sending a short messaging service (SMS) message or a multimedia messaging service (MMS) message to another user through input of information regarding the specific broadcasting program.

Thus, it is troublesome for a user to recommend a specific broadcasting program to another user using the conventional DMB receiving terminal. In addition, when the user directly makes a phone call or edits an SMS or MMS message, the user may inadvertently provide incorrect information to another user due to a bad call state or a typographical error. As described above, it is difficult to exchange information regarding a broadcasting program between users using the conventional DMB receiving terminal.

### SUMMARY OF THE INVENTION

An object of the present invention is to substantially solve at least the above problems and/or disadvantages and to provide at least the advantages below. Accordingly, an object of the present invention is to provide a DMB receiving terminal to easily exchange DMB program information between users and a method of exchanging DMB program information in the DMB receiving terminal.

Another object of the present invention is to provide a DMB receiving terminal to accelerate an exchange of DMB and reduce the time a user spends directly searching a menu for a desired broadcasting program, by smoothly exchanging DMB program information between users, and a method of exchanging DMB program information in the DMB receiving terminal.

According to the present invention, there is provided an apparatus including a DMB receiving unit for receiving DMB data and EPG data, a broadcasting information extractor for extracting user selected broadcasting information from the DMB data and extracting additional broadcasting program information from the EPG data, a memory unit for storing the received EPG data and the extracted broadcasting information, a Caller Information Sending Service (CISS) information generator for generating CISS information including the extracted broadcasting information and broadcasting program information, and a controller for sending a call signal including the CISS information according to input recipient information if a user inputs the information on the recipient, and for terminating transmission of the call signal if a terminal of the recipient receives the call signal.

According to the present invention, there is provided a method including extracting user selected broadcasting information and additional broadcasting program information, generating CISS information including the extracted broadcasting information and the additional broadcasting program information, and sending a call signal including the CISS information according to recipient information input by the user.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a DMB receiving terminal according to the present invention;

FIG. 2 is a flowchart illustrating a method of transmitting broadcasting program information selected by a user to a recipient in a DMB receiving terminal according to the present invention;

FIG. 3 is a detailed flowchart illustrating a process of extracting broadcasting information of broadcasting program selected by a user in a DMB receiving terminal according to the present invention;

FIG. 4 is a detailed flowchart illustrating a process of extracting broadcasting program information corresponding to extracted broadcasting information in a DMB receiving terminal according to the present invention; and

FIG. 5 is a flowchart illustrating a method of outputting a broadcasting program or making a reservation of the broadcasting program using broadcasting program information included in CISS information in a DMB receiving terminal according to the present invention.

### DETAILED DESCRIPTION OF THE PREFERRED EMBODIMENTS

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail for the sake of clarity and conciseness.

In the present invention, when a user desires to recommend a currently output broadcasting program or a specific broadcasting program selected from broadcasting guide information to another user, broadcasting information of the selected broadcasting program is extracted. Additional information of the broadcasting program corresponding to the extracted broadcasting information (hereinafter, broadcasting program information) is searched from stored EPG data. Then, Caller Information Sending Service (CISS) information including the broadcasting program information is generated.

The CISS information is a service for displaying a telephone number and name of a sender on a display unit of a recipient before starting a telephone call. Since sender information, such as a telephone number and a name, can be displayed using the CISS information, an obscene call can be prevented, a missed call can be checked, and the sender can generate his/her own typically used phrases and send them to another user.

A controller of a DMB receiving terminal determines whether information on another user is input by the user. If the information on another user is input, the controller transmits a call signal including the CISS information to another user. Herein, the CISS information includes the broadcasting program information. Thus, if another user receives the call signal including the CISS information, the DMB receiving terminal of the user terminates the transmission of the call signal immediately after the CISS information is received by a DMB receiving terminal of another user.

In this case, the CISS information generated by the user is stored as call-record information in the side of another user. As described above, the CISS information includes the broadcasting program information of the broadcasting program selected by the user. Thus, the user can transmit the broadcasting program information of the selected broadcasting program to another user. In addition, another user can select the broadcasting program, and make an outputting or recording reservation of the broadcasting program using the CISS information.

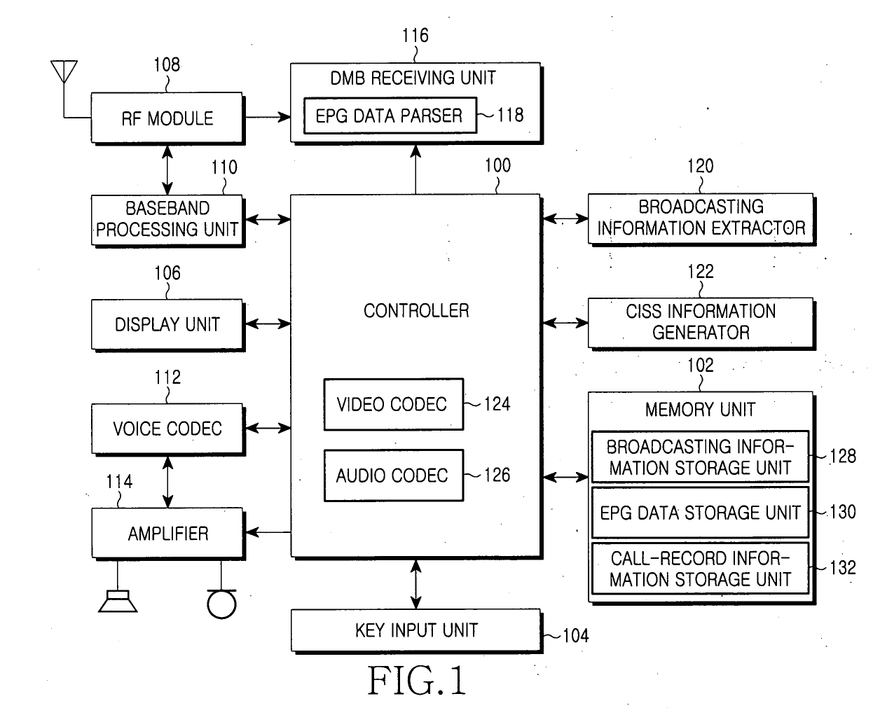

FIG. 1 is a block diagram of a DMB receiving terminal according to the present invention.

Referring to FIG. 1, in the DMB receiving terminal, a memory unit 102, a key input unit 104, a display unit 106, a baseband processing unit 110, a voice coder-decoder (CODEC) 112, an amplifier 114, a broadcasting information extractor 120, a CISS information generator 122 and a DMB receiving unit 116 are connected to a controller 100. The controller 100 processes a voice signal or data according to a protocol for a telephone call, data communication, a wireless Internet connection or DMB, and controls components of the DMB receiving terminal. The controller 100 receives EPG data and a DMB signal from the DMB receiving unit 116. The controller 100 stores the received EPG data in the memory unit 102 and generates broadcasting guide information in response to a user's request. If the user selects to output a DMB program, the controller 100 decodes the received DMB signal to an audio signal and a video signal and respectively outputs the decoded audio and video signals to the amplifier 114 and the display unit 106. The controller 100 controls the display unit 106 to display image information according to key input data of the user by receiving the key input data from the key input unit 104.

The controller 100 extracts broadcasting information of a broadcasting program selected by the user. Herein, the user can select at least one of a currently output broadcasting program and broadcasting programs included in the broadcasting guide information. If a specific broadcasting program is selected by the user, the controller 100 extracts broadcasting information of the selected broadcasting program. Herein, the broadcasting information is unique information of the selected broadcasting program, such as a service identification (ID) of the selected broadcasting program. For example, for satellite DMB (S-DMB), a channel selection method using EPG data is achieved using Program Specific Information (PSI) received from a DMB station. That is, the controller 100 extracts a service ID of DMB data of the broadcasting program selected by the user using the PSI and extracts Packet Element Stream Packet ID (PES PID) corresponding to the extracted service ID. The controller 100 searches for a Walsh code corresponding to information on the extracted PES PID and sets the found Walsh code into the baseband processing unit 110 which selectively receives only DMB data in which the extracted PES PID is included. Thus, for S-DMB, the service ID can be a keyword for receiving only DMB data of the broadcasting program selected by the user and can be unique selected broadcasting program information.

For terrestrial DMB (T-DMB), a channel is set by a DMB receiving terminal receiving Multiplex Configuration Information and Service Information (MCI/SI) from a T-DMB station, tuning a frequency thereof to a frequency of a desired broadcasting channel, and setting a Walsh code into the baseband processing unit 110 to receive only packet data having a PES PID corresponding to a service ID of DMB data of a selected broadcasting program from among packet data received through the tuned frequency. Thus, for T-DMB, the service ID can also be a keyword for receiving only DMB data of the selected broadcasting program and can be unique selected broadcasting program information.

When the user selects the specific broadcasting program, the controller 100 extracts the unique information such as the service ID of the selected broadcasting program. Using the extracted unique information, the controller 100 extracts broadcasting program information of the selected broadcasting program, i.e., information on a service provider, a service name and an on-air time (i.e., whether the broadcasting program is currently on air) of the selected broadcasting program, from EPG data.

The controller 100 generates CISS information including the extracted broadcasting program information and additional broadcasting information. The controller 100 determines whether the user inputs information, such as a telephone number, on another user (i.e., a recipient) to whom the user wants to transmit the broadcasting program information. If it is determined that user has input the information on the recipient, the controller 100 transmits a call signal including the CISS information to the recipient. When the call signal is received by a DMB receiving terminal of the recipient, the controller 100 automatically terminates the transmission of the call signal. Thus, the CISS information including the broadcasting program information is stored as call-record information in the DMB receiving terminal of the recipient, which the recipient can use to obtain the broadcasting program information from the user.

When broadcasting program information included in CISS information is received from another user through call-record information, the DMB receiving terminal of the recipient can allow the recipient to immediately view a broadcasting program according to the received broadcasting program information by outputting the broadcasting program, or make an output or recording reservation of the broadcasting program for viewing at a desired time. That is, if the recipient checks the call-record information, i.e., the CISS information including the specific broadcasting program information, the controller 100 determines whether the broadcasting program according to the broadcasting program information included in the CISS information is on the air, and if so, the controller 100 can immediately change a current channel to a channel according to a service ID of the selected broadcasting program information included in the CISS information. If it is determined that the broadcasting program has yet to begin, the controller 100 can make an outputting or recording reservation of the broadcasting program according to the selected broadcasting program information. Thus, the recipient, who receives the CISS information including the broadcasting program information, can view the broadcasting program recommended by another user or make an outputting or recording reservation of the broadcasting program using the received CISS information.

The memory unit 102 connected to the controller 100 includes storage areas for the EPG data (hereinafter EPG data storage unit 130), the broadcasting program information of a specific broadcasting program extracted by the controller 100 from the EPG data (hereinafter broadcasting information storage unit 128), and the call-record information of a call signal received from another user (hereinafter call-record information storage unit 132), respectively.

The memory unit 102 includes a Read Only Memory (ROM), a flash memory and a Random Access Memory (RAM). The ROM stores programs and various types of reference data for processing and controlling of the controller 100; the RAM provides a working memory of the controller 100; and the flash memory provides an area for storing various types of updatable storage data.

The broadcasting information extractor 120 extracts broadcasting information of a selected broadcasting program and extracts broadcasting program information corresponding to the extracted broadcasting information from stored EPG data. The broadcasting program information is additional information of the selected broadcasting program and includes name, service provider, start time and on-air time information of the selected broadcasting program.

The CISS information generator 122 generates CISS information including the broadcasting information and broadcasting program information extracted by the broadcasting information extractor 120 under a control of the controller 100. When the CISS information is generated, the CISS information generator 122 outputs the generated CISS information to the controller 100 that transmits the CISS information with a call signal to a specific user.

The key input unit 104 includes various keys including numeric keys and provides key input data input by the user to the controller 100. A radio frequency (RF) module 108 transmits/receives an RF signal for a telephone call and a message exchange to/from a base transceiver station (BTS) (not shown) and receives a DMB signal. The RF module 108 also converts a signal received from the BTS to an intermediate frequency (IF) signal, outputs the IF signal to the baseband processing unit 110 connected to the controller 100, converts an IF signal input from the baseband processing unit 110 to an RF signal and transmits the RF signal to the BTS. When the user selects reception of DMB data, the RF module 108 receives the DMB data and outputs the received DMB data to the baseband processing unit 110 connected thereto.

The baseband processing unit 110, which is a baseband analog Application Specific Integrated Circuit (ASIC) (BBA) for providing an interface between the controller 100 and the RF module 108, converts a baseband digital signal input from the controller 100 to an analog IF signal which it outputs to the RF module 108, and converts an analog IF signal input from the RF module 108 to baseband DMB data which it outputs to the controller 100. When the user selects reception of DMB data, the baseband processing unit 110 receives DMB data of a channel set according to key input data input from the controller 100 and outputs the received DMB data to the DMB receiving unit 116.

The DMB receiving unit 116 includes an EPG data parser 118, and if packet data for generating EPG data is included in the received DMB data, the DMB receiving unit 116 generates the EPG data by parsing the packet data and outputs the generated EPG data to the controller 100. The controller 100 stores the input EPG data in the EPG data storage unit 130. The DMB receiving unit 116 demultiplexes the DMB data input through the baseband processing unit 110, extracts audio and video data of the channel selected by the user from among the demultiplexed DMB data, and outputs the extracted audio and video data to the controller 100. The controller 100 decodes the video and audio data by respectively transferring the video data and the audio data to a video CODEC 124 and an audio CODEC 126 to output the DMB program. That is, the controller 100 outputs the decoded video data through the display unit 106 and outputs the decoded audio data through the amplifier 114.

The voice CODEC 112 connected to the controller 100 is connected to a microphone and a speaker through the amplifier 114, outputs voice data obtained by pulse code modulation (PCM) coding a voice signal input from the microphone through the amplifier 114, to the controller 100, and outputs a voice signal obtained by PCM decoding voice data input from the controller 100, to the speaker through the amplifier 114. The amplifier 114 amplifies a voice signal input from the microphone or output to the speaker, and a volume of the speaker and a gain of the microphone are controlled by the controller 100.

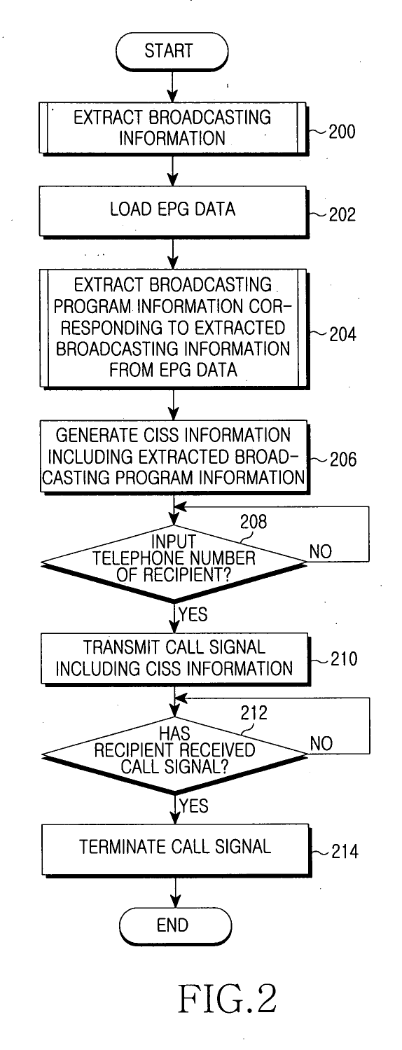

FIG. 2 is a flowchart illustrating a method of transmitting broadcasting program information selected by a user to a recipient in a DMB receiving terminal according to the present invention.

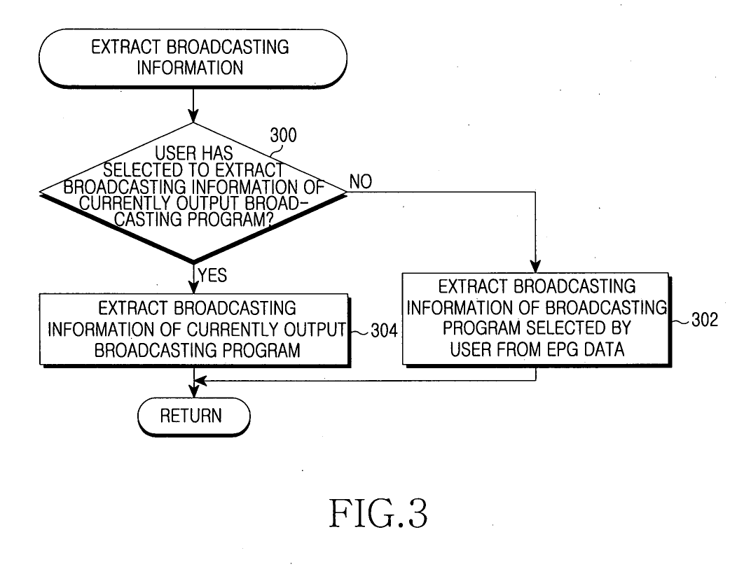

Referring to FIG. 2, if a user desires to transmit broadcasting program information of a currently output broadcasting program or a specific broadcasting program selected from broadcasting guide information to another user, the controller 100 of the DMB receiving terminal according to the present invention extracts broadcasting information of the selected broadcasting program in step 200. A process for the controller 100 to extract the broadcasting information will be described later in detail with reference to FIG. 3. Here, a service ID of the selected broadcasting program can be used as the broadcasting information.

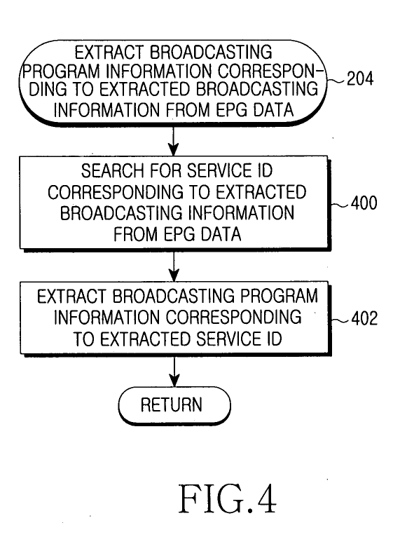

The controller 100, which has extracted the broadcasting information in step 200, loads stored EPG data from the EPG data storage unit 130 in step 202. The controller 100 extracts broadcasting program information corresponding to the extracted broadcasting information from the EPG data in step 204. A process of extracting the broadcasting program information when the service ID of the selected broadcasting program is used as the broadcasting information will be described later in detail with reference to FIG. 4.

After extracting the broadcasting program information corresponding to the user selected broadcasting program in step 204, the controller 100 generates CISS information including the extracted broadcasting information and broadcasting program information in step 206. The controller 100 determines in step 208 whether the user inputs information, i.e., a telephone number, regarding a recipient to whom the CISS information is transmitted. If it is determined in step 208 that the user has input the telephone number of the recipient, the controller 100 transmits a call signal including the generated CISS information to the input telephone number of the recipient in step 210. The controller 100 determines in step 212 whether the transmitted call signal is successfully received by a DMB receiving terminal of the recipient. If it is determined in step 212 that the transmitted call signal has been successfully received, the controller 100 terminates the call signal in step 214.

In this case, the CISS information is stored as call-record information in the DMB receiving terminal of the recipient. The CISS information includes the broadcasting information and broadcasting program information extracted by the user. Thus, if the recipient checks the call-record information, the recipient can obtain the broadcasting information and selected broadcasting program information. As a result, the recipient can view a specific broadcasting program or make an outputting or recording reservation of the specific broadcasting program using the broadcasting information and broadcasting program information included in the CISS information.

FIG. 3 illustrates an operation of the controller 100 to extract the broadcasting information in step 200 of FIG. 2. Referring to FIG. 3, when the user desires to transmit information on a specific broadcasting program, the controller 100 determines in step 300 whether the user selects extraction of broadcasting information of a currently output broadcasting program. If it is determined in step 300 that the user desires to transmit information on the currently output broadcasting program to another user, the controller 100 extracts broadcasting information of a broadcasting program which the user is currently viewing, i.e., a broadcasting program being output through the display unit 106 and the amplifier 114, in step 304.

The process of extracting the broadcasting information is a process for the controller 100 to detect a service ID of the currently output broadcasting program.

If it is determined in step 300 that the user has not selected extraction of the broadcasting information of the currently output broadcasting program, the controller 100 determines that the user has selected extraction of broadcasting information of a specific broadcasting program from EPG data and extracts a service ID corresponding to a name of the broadcasting program selected by the user as broadcasting information of the selected broadcasting program from stored EPG data, i.e., Service Description Table (SDT) data and Event Information Table (EIT) data in step 302. Thus, the user can recommend a specific broadcasting program selected from EPG data or a currently output broadcasting program to another user.

FIG. 4 is a detailed flowchart of step 204 illustrated in FIG. 4, according to the present invention.

Referring to FIG. 4, when the broadcasting information is extracted in step 200 of FIG. 2, the controller 100 of the DMB receiving terminal according to the present invention loads stored EPG data to extract broadcasting program information according to the extracted broadcasting information.

In general, the EPG data includes the SDT data and the EIT data. The SDT data includes information on service providers of a plurality of broadcasting programs including the selected broadcasting program, a unique ID of the selected broadcasting program and a service name of the selected broadcasting program. The EIT data includes information on a name, a start time and an on-air time of every individual broadcasting program. Thus, if the user selects a specific broadcasting program, the controller 100 can extract information on a service provider, a service name, a start time and a duration time of the selected broadcasting program.

Thus, if the EPG data is completely loaded, the controller 100 searches for a service ID corresponding to the broadcasting information extracted in step 200 of FIG. 2 from the loaded EPG data in step 400. The controller 100 extracts broadcasting program information corresponding to the found service ID in step 402. That is, the controller 100 extracts information on a service provider and a service name of the selected broadcasting program from the SDT data, and extracts information on a start time and an on-air time of the selected broadcasting program from the EIT data. The controller 100 generates CISS information including the extracted information as broadcasting program information of the selected broadcasting program together with the extracted broadcasting information in step 206 of FIG. 2. If the user inputs a telephone number of a recipient, the controller 100 transmits a call signal including the CISS information to the recipient. Thus, when the user desires to recommend a specific broadcasting program to another user, the user can transmit broadcasting program information of the specific broadcasting program to another user.

In this case, another user (i.e., recipient), which has received the CISS information including the broadcasting program information, stores the received CISS information in the call-record information storage unit 132. Thereafter, the recipient can view the recommended broadcasting program or make an outputting or recording reservation of the recommended broadcasting program using the broadcasting program information transmitted from the user, which is included in the CISS information stored in the call-record information storage unit 132.

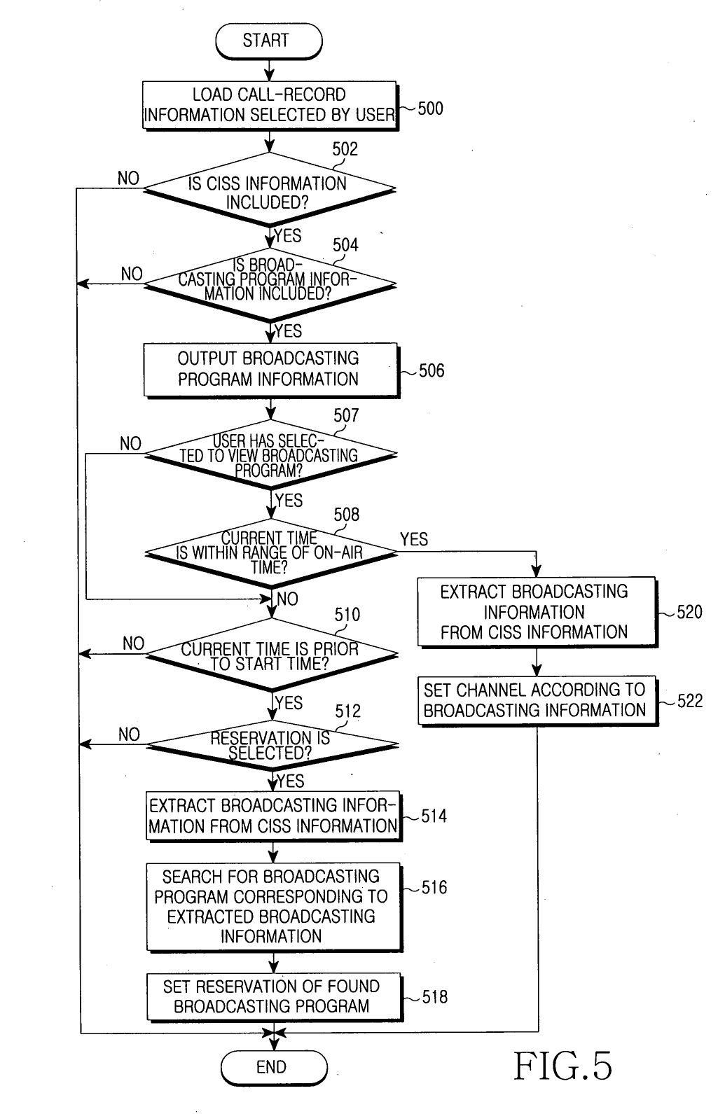

FIG. 5 is a flowchart illustrating a method of outputting a broadcasting program or making a reservation of the broadcasting program using broadcasting program information included in CISS information in a DMB receiving terminal according to the present invention.

Referring to FIG. 5, when a recipient selects specific call-record information, the controller 100 of the DMB receiving terminal loads the selected call-record information in step 500 and determines in step 502 whether CISS information is included in the loaded call-record information. If it is determined in step 502 that CISS information is included in the loaded call-record information, the controller 100 determines in step 504 whether broadcasting program information of a specific broadcasting program is included in the CISS information. If it is determined in step 504 that broadcasting program information is included in the CISS information, the controller 100 outputs the broadcasting program information included in the CISS information in step 506. The controller 100 determines in step 507 whether the user selects to view a broadcasting program corresponding to the broadcasting program information included in the CISS information. If it is determined in step 507 that the user has selected to view the broadcasting program, the controller 100 determines in step 508 whether a current time is within a range of an on-air time of the broadcasting program corresponding to the broadcasting program information included in the CISS information, i.e., whether the broadcasting program is currently on air.

If it is determined in step 508 that the broadcasting program is currently on air, the controller 100 extracts broadcasting information from the CISS information in step 520 and sets a channel corresponding to the extracted broadcasting information in step 522. Thus, when CISS information including broadcasting program information is received, a broadcasting program corresponding to the broadcasting program information included in the CISS information can be immediately output.

If it is determined in step 507 that the user has not selected to view the broadcasting program, or if it is determined in step 508 that the broadcasting program is not currently on air, the controller 100 determines in step 510 whether the current time is prior to a start time of the broadcasting program corresponding to the broadcasting program information included in the CISS information, i.e., whether the broadcasting program has yet to begin. If it is determined in step 510 that the current time is after the start time, i.e., that the broadcasting program has already begun, the controller 100 ends this process of outputting a broadcasting program or making a reservation of the broadcasting program using broadcasting program information included in CISS information.

If it is determined in step 510 that the current time is prior to the start time of the broadcasting program corresponding to the broadcasting program information included in the CISS information, the controller 100 determines in step 512 whether the user selects to make a reservation of the broadcasting program. If it is determined in step 512 that the user has not selected to make a reservation of the broadcasting program, the controller 100 ends this process of outputting a broadcasting program or making a reservation of the broadcasting program using broadcasting program information included in CISS information. If it is determined in step 512 that the user has selected to make a reservation of the broadcasting program, the controller 100 extracts broadcasting information from the CISS information in step 514. The controller 100 searches for a broadcasting program corresponding to the extracted broadcasting information in step 516. The controller 100 makes an outputting or recording reservation of the found broadcasting program according to the user's selection in step 518. Thereafter, the controller 100 ends this process. Thus, when a user receives CISS information including broadcasting program information from another user, the user can view a specific broadcasting program corresponding to the broadcasting program information included in the CISS information or make an outputting or recording reservation of the specific broadcasting program.

As described above, according to the present invention, by allowing users to easily exchange broadcasting program information of DMB, exchange of DMB can be accelerated, and time spent directly searching for a desired broadcasting program through menu can be reduced.

While the invention has been shown and described with reference to a certain preferred embodiment thereof, it will be understood by those skilled in the art that various changes in form and details may be made therein without departing from the spirit and scope of the invention. In particular, although a service ID of a specific broadcasting program is used as broadcasting information in the embodiments of the present invention, the invention is not limited to this. For example, a Program Map Table (PMT) PID used for setting a channel of the specific broadcasting program can be used as the broadcasting information.

In general, the PMT PID is information used to set a channel in S-DMB, and when a user selects a specific broadcasting program using SDT data, the PMT PID is used to set a PID range of packet data corresponding to the specific broadcasting program. Thus, when the PMT PID is changed, received packet data is also changed, and accordingly the PMT PID is unique for every broadcasting program. Accordingly, the PMT PID can be used as the broadcasting information. Thus it will be understood by those skilled in the art that various changes in form and details may be made therein without departing from the spirit and scope of the invention as defined by the appended claims.

What is claimed is:

1. An apparatus for transmitting DMB program information in a digital multimedia broadcasting (DMB) receiving terminal, the apparatus comprising:
a DMB receiving unit for receiving DMB data and Electronic Program Guide (EPG) data;
a broadcasting information extractor for extracting broadcasting information of a selected broadcasting program from the DMB data and additional broadcasting program information of the selected broadcasting program from the EPG data;
a memory unit for storing the received EPG data and the extracted broadcasting information;
a Caller Information Sending Service (CISS) information generator for generating CISS information including the extracted broadcasting information and the additional broadcasting program information; and
a controller for sending a call signal including the CISS information according to input recipient information, if information on a recipient is input by the user, and terminating transmission of the call signal, if a terminal of the recipient receives the call signal.

2. The apparatus of claim 1, wherein the controller stores broadcasting information and broadcasting program information included in the CISS information with the call signal in the memory unit as call-record information if a call signal including CISS information is received from another user.

3. The apparatus of claim 2, wherein the controller performs one of outputting, making an outputting reservation, or making a recording reservation of a broadcasting program corresponding to the broadcasting information included in the CISS information according to the user's selection.

4. The apparatus of claim 3, wherein the controller compares a current time to start time information and on-air time information of the broadcasting program corresponding to the broadcasting information, and outputs the broadcasting program if it is determined that the broadcasting program is on the air.

5. The apparatus of claim 3, wherein the controller compares a current time to start time information and on-air time information of the broadcasting program corresponding to the broadcasting information, and makes an outputting or recording reservation of the broadcasting program according to the user's selection if it is determined that the broadcasting program has not begun.

6. The apparatus of claim 1, wherein the broadcasting information extractor extracts, from the EPG data, broadcasting information of a currently output broadcasting program and additional broadcasting program information of the broadcasting program corresponding to the extracted broadcasting information.

7. The apparatus of claim 1, wherein the broadcasting information extractor extracts, from the EPG data, broadcasting information of a user selected broadcasting program and additional broadcasting program information of the broadcasting program corresponding to the extracted broadcasting information.

8. The apparatus of claim 1, wherein the broadcasting information is a service identification (ID) or a Program Map Table Packet ID (PMT PID) of the selected broadcasting program from broadcasting program information stored in the EPG data.

9. The apparatus of claim 1, wherein the broadcasting program information includes information on a service provider, a name, a start time and an on-air time of the selected broadcasting program.

10. A method of transmitting digital multimedia broadcasting (DMB) program information in a DMB receiving terminal including a broadcasting information extractor for extracting broadcasting information, which is unique information of a specific broadcasting program, and additional broadcasting program information of the specific broadcasting program, and a Caller Information Sending Service (CISS) information generator for generating CISS information including the extracted broadcasting information and additional broadcasting program information, the method comprising the steps of:
extracting broadcasting information of a user selected broadcasting program, and additional broadcasting program information of the selected broadcasting program;
generating CISS information including the extracted broadcasting information and the additional broadcasting program information; and
sending a call signal including the CISS information according to recipient information input by the user.

11. The method of claim 10, further comprising terminating the call signal if the recipient successfully receives the call signal.

12. The method of claim 10, further comprising checking CISS information included in the call-record information, if the user checks stored call-record information, , and outputting a broadcasting program corresponding to the broadcasting information or making an outputting or a recording reservation of the broadcasting program, if the CISS information includes broadcasting information and broadcasting program information.

13. The method of claim 10, wherein extracting broadcasting information further comprises:
determining whether the user selects to extract broadcasting information of a broadcasting program currently output to the user;
extracting the broadcasting information of the currently output broadcasting program or broadcasting information of a specific broadcasting program selected using the EPG data by the user according to the determination result;
searching for additional broadcasting program information of the broadcasting program corresponding to the extracted broadcasting information, from the EPG data; and
extracting found additional broadcasting program information.

14. The method of claim 10, wherein the broadcasting information is a service identification (ID) or a Program Map Table Packet ID (PMT PID) of the selected broadcasting program out of broadcasting program information stored in the EPG data.

15. The method of claim 10, wherein the broadcasting program information includes information on a service provider, a name, a start time and an on-air time of the selected broadcasting program.

16. The method of claim 12, wherein the step of outputting a broadcasting program corresponding to the broadcasting information or making a recording reservation of the broadcasting program comprises:
determining whether CISS information is included in call-record information selected by the user;
determining whether broadcasting information and broadcasting program information are included in the CISS information, if it is determined that CISS information is included in the call-record information;
outputting the broadcasting information and the broadcasting program information, if it is determined that broadcasting information and broadcasting program information are included in the CISS information; and
outputting a broadcasting program corresponding to the broadcasting information according to the user's selection.

17. The method of claim 16, wherein outputting the broadcasting program further comprises:
determining whether a current time is within a range of an on-air time of the broadcasting program by referring to a start time and the on-air time of the broadcasting program, which are included in the CISS information;
outputting the broadcasting program corresponding to the broadcasting information included in the CISS information by setting a channel corresponding to the broadcasting information according to the user's selection, if it is determined that the current time is within the range of the on-air time of the broadcasting program.

18. The method of claim 17, further comprising making an outputting or recording reservation of the broadcasting information according to the user's selection, if it is determined that the current time is prior to the start time of the broadcasting program.

19. The method of claim 18, wherein making the recording reservation of the broadcasting information further comprises:
determining whether the current time is prior to the start time of the broadcasting program;
determining whether the user selects to make an outputting or recording reservation of the broadcasting program, if it is determined that the current time is prior to the start time of the broadcasting program,;
extracting the broadcasting information from the CISS information, if it is determined that the user has selected to make the outputting or the recording reservation of the broadcasting program;
searching for a broadcasting program corresponding to the extracted broadcasting information from the EPG data; and
making a recording reservation of found broadcasting program or setting a time for output the found broadcasting program.
